(19) United States
(12) Patent Application Publication
(10) Pub. No.: US 2022/0168842 A1
(43) Pub. Date: Jun. 2, 2022

(54) SUBSTRATE TREATMENT APPARATUS AND SUBSTRATE TREATMENT METHOD

(71) Applicant: Tokyo Electron Limited, Tokyo (JP)

(72) Inventor: Daisuke Shirasawa, Miyagi (JP)

(73) Assignee: Tokyo Electron Limited, Tokyo (JP)

(21) Appl. No.: 17/519,594

(22) Filed: Nov. 5, 2021

(30) Foreign Application Priority Data
Nov. 30, 2020 (JP) 2020-198159

(51) Int. Cl. B23K 26/16; G02B 19/00; B23K 26/06; B23K 26/12

(52) U.S. Cl. CPC B23K 26/16; G02B 19/0028; B23K 2103/56; B23K 26/0665; B23K 26/127; G02B 19/0047

(57) ABSTRACT

A substrate treatment apparatus includes a chamber, a member provided inside the chamber, a light source configured to emit a laser beam, an optical waveguide optically connected to the light source and configured to guide a laser beam emitted from the light source, and an optical system provided at an outer peripheral part of the member, optically connected to the optical waveguide, and configured to condense a laser beam guided by the optical waveguide to a focal feature located around the outer peripheral part.

### CROSS-REFERENCE TO RELATED APPLICATION

This application claims priority to Japanese Patent Application No. 2020-198159 filed on Nov. 30, 2020, the entire disclosure of which being incorporated herein by reference

### BACKGROUND

### 1. Technical Field

An illustrative embodiment of the present disclosure relates to a substrate treatment apparatus and a substrate treatment method.

### 2. Description of the Related Art

The technology described in Japanese Unexamined Patent Application Publication No. 2008-137104 is suggested as a technology concerning optical tweezers using optical mechanical properties. In this technology, a radially polarized laser beam is used as a light beam of the optical tweezers. The radially polarized laser beam is directly generated from an optical resonator for generating a radially polarized laser beam, does not contain an s-polarized component at all, and is composed of only a p-polarized component. A reflecting mirror is used to guide a laser beam, and an immersion lens is used to condense light. With this configuration, fine particles (particles) present in a vacuum or in a liquid and larger than the wavelength of light can be captured.

### SUMMARY

The present disclosure provides a technology for reducing diffusion of particles.

One illustrative embodiment provides a substrate treatment apparatus. The substrate treatment apparatus includes a chamber, a member, a light source, an optical waveguide, and an optical system. The member is provided inside the chamber. The light source is configured to emit a laser beam. The optical waveguide is optically connected to the light source and configured to guide a laser beam emitted from the light source. The optical system is provided at an outer peripheral part of the member, optically connected to the optical waveguide, and configured to emit a laser beam emitted from the light source and guided by the optical waveguide so as to condense the laser beam to a focal point around the member.

### BRIEF DESCRIPTION OF THE DRAWINGS

FIG. 1 is a view showing a substrate treatment apparatus according to an illustrative embodiment;

FIG. 2 is a view schematically showing the configuration of an optical system according to one example;

FIG. 3 is a view schematically showing the function of an optical system according to one example by using a sectional shape of the optical system;

FIG. 4 is a view schematically showing the function of another optical system according to one example by using a sectional shape of the optical system;

FIG. 5 is a view schematically showing the function of another optical system according to one example by using a sectional shape of the optical system;

FIG. 6 is a flowchart showing a substrate treatment method according to the illustrative embodiment;

FIG. 7 is a flowchart showing another substrate treatment method according to the illustrative embodiment;

FIG. 8 is a view schematically showing the function of another optical system according to one example by using a sectional shape of the optical system;

FIG. 9 is a view schematically showing the function of another optical system according to one example by using a sectional shape of the optical system;

FIG. 10 is a view showing a substrate treatment apparatus according to another illustrative embodiment;

FIG. 11 is a view showing a substrate treatment apparatus according to another illustrative embodiment;

FIG. 12 is a view showing a substrate treatment apparatus according to another illustrative embodiment;

FIG. 13 is a view showing a substrate treatment apparatus according to another illustrative embodiment;

FIG. 14 is a view showing a substrate treatment apparatus according to another illustrative embodiment;

FIG. 15 is a view showing a substrate treatment apparatus according to another illustrative embodiment;

FIG. 16 is a view showing a substrate treatment apparatus according to another illustrative embodiment; and

FIG. 17 is a view showing a substrate treatment apparatus according to another illustrative embodiment.

### DESCRIPTION OF THE PREFERRED EMBODIMENTS

Hereinafter, various illustrative embodiments will be described.

One illustrative embodiment provides a substrate treatment apparatus. The substrate treatment apparatus may include a chamber, a substrate support, a light source, an optical waveguide, and an optical system. The substrate support may be provided inside the chamber and configured to support a substrate. The light source may be configured to emit a laser beam. The optical waveguide may be optically connected to the light source and configured to guide a laser beam emitted from the light source. The optical system may be provided at an outer peripheral part of the substrate support, may be optically connected to the laser beam, and may be configured to emit a laser beam emitted from the light source and guided by the optical waveguide so as to condense the laser beam to a focal point around the outer peripheral part.

Particles around the outer peripheral part can be collected to the focal point by a laser beam. In this case, a laser beam condensed to the focal point can function as optical tweezers for the particles. Therefore, diffusion of particles produced inside the chamber into the chamber during a substrate treatment is reduced.

In one illustrative embodiment, the optical system may include a light diffusion portion and a condensing portion. The optical waveguide may extend from a lower side of the substrate support toward a surface of the substrate support on which a substrate is placed. The light diffusion portion may be optically connected to the optical waveguide via an end portion of the optical waveguide. The condensing portion may be optically connected to a reflecting portion and configured to condense a laser beam emitted from the reflecting portion to the focal point.

In one illustrative embodiment, the optical system may further include a reflecting portion. The light diffusion portion may be configured to emit a laser beam guided by the optical waveguide toward a surface while diffusing the laser beam along the surface. The reflecting portion may be provided on the light diffusion portion, optically connected to the light diffusion portion, and configured to emit a laser beam, emitted from the light diffusion portion toward the surface, toward the condensing portion provided adjacent to the reflecting portion. The condensing portion may be optically connected to the reflecting portion and configured to condense a laser beam emitted from the reflecting portion to the focal point.

In one illustrative embodiment, the condensing portion may have a convex shape protruding from the outer peripheral part toward the focal point.

In one illustrative embodiment, the condensing portion may have a concave shape recessed from the focal point toward an inside of the outer peripheral part.

In one illustrative embodiment, the condensing portion may be embedded in a recess provided at the outer peripheral part between the reflecting portion and the focal point.

One illustrative embodiment may further include an edge ring disposed so as to surround the outer peripheral part. The focal point may be located between the outer peripheral part and an inner surface of the edge ring. The inner surface may have a concave shape recessed from the focal point toward an inner side of the edge ring and configured to reflect a laser beam emitted from the condensing portion and condense the laser beam to the focal point.

One illustrative embodiment may further include a control unit configured to control start and stop of outputting a laser beam with the light source.

One illustrative embodiment may further include a gas source group. The control unit may be configured to execute control such that, after start of outputting a laser beam, a substrate is carried into the chamber, the substrate is subjected to a substrate treatment by using gas supplied from the gas source group, the substrate is carried out from the chamber, and then output of a laser beam is stopped. The control unit may be further configured to, after stop of outputting a laser beam, execute control such that particles are removed by using gas supplied from the gas source group.

In one illustrative embodiment, the control unit may be configured to execute control such that, after start of outputting a laser beam, a series of processes that a substrate is carried into the chamber, the substrate is subjected to a substrate treatment, and the substrate is carried out from the chamber is repeated multiple times, then output of a laser beam is stopped, and the particles are removed. The control unit may be further configured to, after the series of processes is repeated multiple times, execute control such that output of a laser beam is stopped, and the particles are removed.

In one illustrative embodiment, the substrate treatment may be a plasma treatment for treating a substrate supported by the substrate support with plasma.

In one illustrative embodiment, the substrate support may include an electrostatic chuck, and the electrostatic chuck may include the outer peripheral part.

One illustrative embodiment provides a substrate treatment method to be performed in a substrate treatment apparatus. The substrate treatment apparatus may include a chamber, a substrate support, a light source, an optical waveguide, an optical system, and a gas source group. The substrate support may be provided inside the chamber and configured to support a substrate. The light source may be configured to emit a laser beam. The optical waveguide may be optically connected to the light source and configured to guide a laser beam emitted from the light source. The optical system may be provided at an outer peripheral part of the substrate support, optically connected to the optical waveguide, and configured to emit a laser beam guided by the optical waveguide so as to condense the laser beam to a focal point around the outer peripheral part. The substrate treatment method may include a step of starting output of a laser beam, a step of carrying a substrate into the chamber, and a step of performing a substrate treatment on the substrate by using gas supplied from the gas source group. The method may further include a step of carrying the substrate out from the chamber, a step of stopping output of a laser beam, and a step of removing particles by using gas supplied from the gas source group.

In one illustrative embodiment, after a series of processes including a step of carrying the substrate in, a step of performing a substrate treatment, and a step of carrying the substrate out is repeated multiple times, a step of stopping output of a laser beam may be performed, and then a step of removing the particles may be performed.

In one illustrative embodiment, the substrate treatment may be a plasma treatment for treating a substrate with plasma.

One illustrative embodiment provides a substrate treatment apparatus. The substrate treatment apparatus includes a chamber, a member, a light source, an optical waveguide, and an optical system. The member is provided inside the chamber. The light source is configured to emit a laser beam. The optical waveguide is optically connected to the light source and configured to guide a laser beam emitted from the light source. The optical system is provided at an outer peripheral part of the member, optically connected to the optical waveguide, and configured to emit a laser beam emitted from the light source and guided by the optical waveguide so as to condense the laser beam to a focal point around the member.

Particles around the outer peripheral part can be collected to the focal point by a laser beam. In this case, a laser beam condensed to the focal point can function as optical tweezers for the particles. Therefore, diffusion of particles produced inside the chamber into the chamber during a substrate treatment is reduced.

In one illustrative embodiment, the optical system may include a light diffusion portion and a condensing portion. The light diffusion portion may be optically connected to the optical waveguide via an end portion of the optical waveguide. The condensing portion may be configured to condense a laser beam emitted from the light diffusion portion to the focal point.

In one illustrative embodiment, the optical system may further include a reflecting portion. The light diffusion portion may be configured to emit a laser beam guided by the optical waveguide while diffusing the laser beam. The reflecting portion may be provided on the light diffusion portion, optically connected to the light diffusion portion, and configured to emit a laser beam, emitted from the light diffusion portion, toward the condensing portion provided adjacent to the reflecting portion. The condensing portion may be optically connected to the reflecting portion and configured to condense a laser beam emitted from the reflecting portion to the focal point.

In one illustrative embodiment, the member may be a substrate support provided inside the chamber and configured to support a substrate.

In one illustrative embodiment, the substrate treatment apparatus may further include a substrate support, a support portion, an exhaust pipe, and a baffle plate. The substrate support may be configured to support a substrate. The support portion may extend upward from a bottom of the chamber and may be configured to support the substrate support. The exhaust pipe may be connected to the bottom. The baffle plate may be provided between a side wall of the chamber and the support portion above the exhaust pipe. The member may be the support portion. The condensing portion may be provided on a side of the support portion, facing the side wall and configured to condense a laser beam emitted from the reflecting portion to a focal point between the side and the side wall above the baffle plate.

In one illustrative embodiment, the substrate treatment apparatus may further include a substrate support, a support portion, an exhaust pipe, and a baffle portion. The substrate support may be configured to support a substrate. The support portion may extend upward from a bottom of the chamber and may be configured to support the substrate support. The exhaust pipe may be connected to the bottom. The baffle portion may be provided between a side wall of the chamber and the support portion above the exhaust pipe. The baffle portion may have a first protruding portion and a second protruding portion. The first protruding portion may be provided on the support portion and extend from the support portion toward the side wall. The second protruding portion may be provided on the side wall above or below the first protruding portion and extend from the side wall toward the support portion. A gap may be provided between the first protruding portion and the side wall and between the second protruding portion and the support portion. The first protruding portion may be disposed above the second protruding portion. A bottom surface of the first protruding portion and a top surface of the second protruding portion may face each other and may be spaced apart from each other. The member may be the first protruding portion. The condensing portion may be provided on the bottom surface of the first protruding portion and configured to condense a laser beam emitted from the reflecting portion to the focal point in a gap between the first protruding portion and the second protruding portion.

In one illustrative embodiment, a concave shape may be provided on an inner surface of the side wall so as to face the condensing portion. The focal point may be located between the condensing portion and the concave shape. The concave shape may be a shape recessed toward an inner side of the side wall and configured to reflect a laser beam emitted from the condensing portion and condense the laser beam to the focal point.

In one illustrative embodiment, a concave shape may be provided on the top surface of the second protruding portion so as to face the condensing portion. The focal point may be located between the condensing portion and the concave shape. The concave shape may be a shape recessed toward an inner side of the second protruding portion and configured to reflect a laser beam emitted from the condensing portion and condense the laser beam to the focal point.

One illustrative embodiment provides a substrate treatment method to be performed in a substrate treatment apparatus. The substrate treatment apparatus includes a chamber, a member, a light source, an optical waveguide, an optical system, and a gas source group. The member may be provided inside the chamber. The light source may be configured to emit a laser beam. The optical waveguide may be optically connected to the light source and configured to guide a laser beam emitted from the light source. The optical system may be provided at an outer peripheral part of the member, optically connected to the laser beam, and configured to emit a laser beam guided by the optical waveguide so as to condense the laser beam to a focal point around the outer peripheral part. The substrate treatment method may include a step of starting output of a laser beam, a step of carrying a substrate into the chamber, and a step of performing a substrate treatment on the substrate by using gas supplied from the gas source group. The method may further include a step of carrying the substrate out from the chamber, a step of stopping output of a laser beam, and a step of removing particles by using gas supplied from the gas source group.

In one illustrative embodiment, a concave member may be provided on the inner surface of the side wall so as to face the condensing portion. The focal point may be located between the condensing portion and the concave member. The concave member may have a concave shape recessed toward an inner side of the side wall and configured to reflect a laser beam emitted from the condensing portion and condense the laser beam to the focal point.

In one illustrative embodiment, the side wall and the second protruding portion may be provided separately from each other.

Hereinafter, various illustrative embodiments will be described in detail with reference to the accompanying drawings. In the drawings, like reference signs are assigned to the same or corresponding portions.

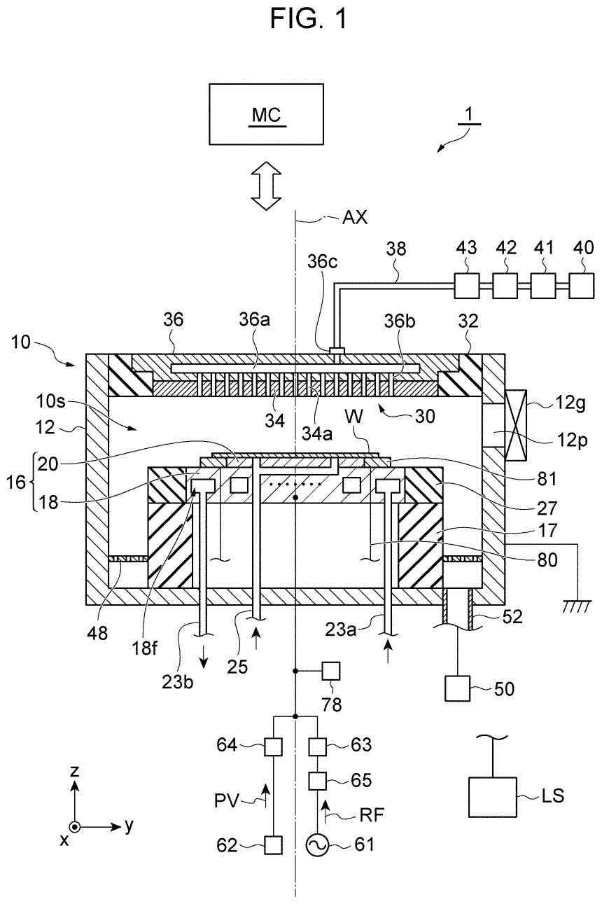

FIG. 1 is a diagram schematically showing a substrate treatment apparatus 1 according to one illustrative embodiment. The substrate treatment apparatus 1 shown in FIG. 1 is a capacitive coupling-type substrate treatment apparatus. The substrate treatment apparatus 1 includes a chamber 10. The chamber 10 provides an internal space 10s inside. The central axis of the internal space 10s is an axis AX extending in a vertical direction. A z-axis direction shown in FIG. 1 to FIG. 5 represents a vertically upward direction, and an x-axis and a y-axis can define a plane parallel to a horizontal plane and are perpendicular to the vertically upward direction (z-axis direction) (the same applies in FIG. 1 to FIG. 5).

In one embodiment, the chamber 10 includes a chamber body 12. The chamber body 12 has a substantially cylindrical shape. The internal space 10s is provided inside the chamber body 12. The chamber body 12 is made of, for example aluminum. The chamber body 12 is electrically grounded. A plasma-resistant coating is formed on the inner wall surface of the chamber body 12, that is, a wall surface defining the internal space 10s. The coating can be a ceramic coating, such as a coating formed by anodic treatment or a coating made of yttrium oxide.

A passage 12p is formed in the side wall of the chamber body 12. A substrate W is passed through the passage 12p when conveyed between the internal space 10s and the outside of the chamber 10. To open or close the passage 12p, a gate valve 12g is provided along the side wall of the chamber body 12.

The substrate treatment apparatus 1 further includes a substrate support 16 (stage). The substrate support 16 is configured to support the substrate W placed on the substrate support 16 inside the chamber 10. The substrate W has a substantially disc shape. The substrate support 16 is supported by a support portion 17. The support portion 17 extends upward from the bottom of the chamber body 12. The support portion 17 has a substantially cylindrical shape. The support portion 17 is made of an insulating material, such as quartz and alumina.

The substrate support 16 includes a lower electrode 18 and an electrostatic chuck 20. The lower electrode 18 and the electrostatic chuck 20 are provided inside the chamber 10. The lower electrode 18 is made of an electrically conductive material, such as aluminum, and has a substantially disc shape.

A channel 18f is formed in the lower electrode 18. The channel 18f is a channel for a heat exchange medium. A liquid refrigerant or a refrigerant that cools the lower electrode 18 with its vaporization (for example, a chlorofluorocarbon) is used as the heat exchange medium. A supply device (for example, a chiller unit) for a heat exchange medium is connected to the channel 18f. The supply device is provided outside the chamber 10. The heat exchange medium is supplied from the supply device to the channel 18f via a pipe 23a. The heat exchange medium supplied to the channel 18f is returned to the supply device via a pipe 23b.

The electrostatic chuck 20 is provided on the lower electrode 18. When a substrate W is treated in the internal space 10s, the substrate W is placed on the electrostatic chuck 20 and held by the electrostatic chuck 20.

The electrostatic chuck 20 includes a body and an electrode. The body of the electrostatic chuck 20 is made of a dielectric, such as aluminum oxide and aluminum nitride. The body of the electrostatic chuck 20 has a substantially disc shape. The central axis of the electrostatic chuck 20 substantially coincides with the axis AX. The electrode of the electrostatic chuck 20 is provided in the body. The electrode of the electrostatic chuck 20 has a film shape. A direct-current power supply is electrically connected to the electrode of the electrostatic chuck 20 via a switch. When a voltage from the direct-current power supply is applied to the electrode of the electrostatic chuck 20, an electrostatic attraction is generated between the electrostatic chuck 20 and the substrate W. With the generated electrostatic attraction, the substrate W is attracted to the electrostatic chuck 20 and held by the electrostatic chuck 20.

The electrostatic chuck 20 includes a substrate placement region. The substrate placement region is a region having a substantially disc shape. The central axis of the substrate placement region substantially coincides with the axis AX. When the substrate W is treated inside the chamber 10, the substrate W is placed on the top surface of the substrate placement region.

The substrate treatment apparatus 1 can further include a gas supply line 25. The gas supply line 25 supplies heat transfer gas, for example, He gas, from a gas supply mechanism to a gap between the top surface of the electrostatic chuck 20 and the back surface (bottom surface) of the substrate W.

The substrate treatment apparatus 1 can further include an insulating region 27. The insulating region 27 is disposed on the support portion 17. The insulating region 27 is disposed outside the lower electrode 18 in a radial direction with respect to the axis AX. The insulating region 27 extends in a circumferential direction along the outer periphery of the lower electrode 18. The insulating region 27 is made of an insulator, such as quartz.

The substrate treatment apparatus 1 further includes an upper electrode 30. The upper electrode 30 is provided above the substrate support 16. The upper electrode 30 closes a top opening of the chamber body 12 together with a member 32. The member 32 has insulating properties. The upper electrode 30 is supported at the upper part of the chamber body 12 via the member 32.

The upper electrode 30 includes a top plate 34 and a support 36. The bottom surface of the top plate 34 defines the internal space 10s. A plurality of gas discharge holes 34a is formed in the top plate 34. Each of the plurality of gas discharge holes 34a extends through the top plate 34 in a plate thickness direction (vertical direction). Although not limited, the top plate 34 is made of, for example, silicon. Alternatively, the top plate 34 can have a structure such that a plasma-resistant coating is provided on the surface of a member made of aluminum. The coating can be a ceramic coating, such as a coating formed by anodic treatment or a coating made of yttrium oxide.

The support 36 detachably supports the top plate 34. The support 36 is made of an electrically conductive material, such as aluminum. A gas diffusion chamber 36a is provided in the support 36. A plurality of gas holes 36b extends downward from the gas diffusion chamber 36a. The plurality of gas holes 36b respectively communicates with the plurality of gas discharge holes 34a. A gas introduction port 36c is formed in the support 36. The gas introduction port 36c is connected to the gas diffusion chamber 36a. A gas supply pipe 38 is connected to the gas introduction port 36c.

A gas source group 40 is connected to the gas supply pipe 38 via a valve group 41, a flow rate controller group 42, and a valve group 43. The gas source group 40, the valve group 41, the flow rate controller group 42, and the valve group 43 make up a gas supply unit. The gas source group 40 includes a plurality of gas sources. Each of the valve group 41 and the valve group 43 includes a plurality of valves (for example, on-off valves). The flow rate controller group 42 includes a plurality of flow rate controllers. Each of the plurality of flow rate controllers of the flow rate controller group 42 is a mass flow controller or a pressure control flow rate controller. Each of the plurality of gas sources of the gas source group 40 is connected to the gas supply pipe 38 via an associated one of the valves of the valve group 41, an associated one of the flow rate controllers of the flow rate controller group 42, and an associated one of the valves of the valve group 43. The substrate treatment apparatus 1 is capable of supplying gas from one or more gas sources selected from among the plurality of gas sources of the gas source group 40 to the internal space 10s at an individually adjusted flow rate.

A baffle plate 48 is provided between the side wall of the chamber body 12 and the substrate support 16 or the support portion 17. The baffle plate 48 can be made by, for example, coating a member made of aluminum with ceramics, such as yttrium oxide. A large number of through-holes are formed in the baffle plate 48. An exhaust pipe 52 is connected to the bottom of the chamber body 12 below the baffle plate 48. An exhaust device 50 is connected to the exhaust pipe 52. The exhaust device 50 includes a pressure controller, such as an automatic pressure control valve, and a vacuum pump, such as a turbo-molecular pump. The exhaust device 50 is capable of decompressing the pressure in the internal space 10s.

The substrate treatment apparatus 1 further includes a radio-frequency power supply 61. The radio-frequency power supply 61 is a power supply that generates radio-frequency power RF. Radio-frequency power RF is used to generate plasma from gas in the chamber 10. The frequency of the radio-frequency power RF can be a frequency within the range of 27 MHz to 100 MHz. The radio-frequency power supply 61 is connected to the lower electrode 18 via a matching circuit 63 in order to supply radio-frequency power RF to the lower electrode 18. The matching circuit 63 is configured to match the output impedance of the radio-frequency power supply 61 with a load-side (for example, lower electrode 18-side) impedance, that is, a load impedance. The radio-frequency power supply 61 may be further electrically connected to the lower electrode 18 via a power sensor 65. The power sensor 65 can include a directional coupler and a reflected wave power detector. The directional coupler is configured to apply at least part of a reflected wave from the load of the radio-frequency power supply 61 to the reflected wave power detector. The reflected wave power detector is configured to detect the power level of a reflected wave received from the directional coupler. The radio-frequency power supply 61 does not need to be electrically connected to the lower electrode 18 and may be connected to the upper electrode 30 via the matching circuit 63.

The substrate treatment apparatus 1 further includes a bias power supply 62. The bias power supply 62 is electrically connected to the lower electrode 18. In one embodiment, the bias power supply 62 is electrically connected to the lower electrode 18 via a low pass filter 64.

When a substrate treatment (for example, a plasma treatment in which a substrate supported by the substrate support 16 is treated with plasma, and the same applies below) is performed in the substrate treatment apparatus 1, gas is supplied to the internal space 10s. When the radio-frequency power RF is supplied, gas is excited in the internal space 10s. As a result, plasma is generated in the internal space 10s. The substrate W supported by the substrate support 16 is treated with chemical species, such as ions and radicals of plasma. For example, the substrate is etched by chemical species of plasma. In the substrate treatment apparatus 1, when a pulsed cathodic direct-current voltage PV is applied to the lower electrode 18, ions of plasma are accelerated toward the substrate W.

In the substrate treatment apparatus 1, the radio-frequency power RF is supplied to the lower electrode 18. Alternatively, the radio-frequency power RF may be supplied to the upper electrode 30.

In one embodiment, the substrate treatment apparatus 1 may further include a voltage sensor 78. The voltage sensor 78 is configured to directly or indirectly measure the potential of the substrate W. In the example shown in FIG. 1, the voltage sensor 78 is configured to measure the potential of the lower electrode 18. Specifically, the voltage sensor 78 measures the potential of a feed line connected between the lower electrode 18 and the bias power supply 62.

In the period during which the cathodic pulsed direct-current voltage PV is applied to the lower electrode 18, the potential difference between plasma and the lower electrode 18 (or the substrate W) is relatively large. Therefore, in the period during which the cathodic pulsed direct-current voltage PV is applied to the lower electrode 18, secondary electrons generated by collision of ions with the substrate W are accelerated by a large potential difference applied to a sheath on the substrate W between plasma and the lower electrode 18, and large energy is obtained. For this reason, in the period during which the cathodic pulsed direct-current voltage PV is applied to the lower electrode 18, the energy of secondary electrons is relatively high, and electron temperature in plasma and the degree of dissociation of gas in plasma are high. On the other hand, in the period during which no cathodic pulsed direct-current voltage PV is applied to the lower electrode 18, the potential difference between plasma and the lower electrode 18 (or the substrate W) is relatively low. Therefore, in the period during which no cathodic pulsed direct-current voltage PV is applied to the lower electrode 18, the potential difference that accelerates secondary electrons is small, so the energy of secondary electrons is relatively low, and electron temperature in plasma and the degree of dissociation of gas in plasma are low. Therefore, with the substrate treatment apparatus 1, it is possible to control electron temperature in plasma and the degree of dissociation of gas in plasma.

The substrate treatment apparatus 1 further includes a control unit MC. In one embodiment, the control unit MC is a computer (circuitry contained one or more circuit boards, such as a microcontroller, embedded controller, or even one or more CPUs/GPUs) including a processor, a storage device, an input device, a display device, and the like and controls the portions of the substrate treatment apparatus 1. The MC may also be implemented as hardwired discrete and/or pre-programmed circuitry (one or more circuits) such as application specific integrated circuits (ASIC) or programmable logic. Furthermore, the MC may be implemented in circuitry that is distributed between circuitry located adjacent to the substrate treatment apparatus 1 and a remote location (e.g., clouds resources) that are connected via wired or wireless communication channels. The control unit MC runs a control program (computer readable instructions) stored in the storage device and controls the portions of the substrate treatment apparatus 1 based on recipe data stored in the storage device. Through control of the control unit MC, a process specified by the recipe data is performed in the substrate treatment apparatus 1. A substrate treatment method MT1 and a substrate treatment method MT2 (described later) can be performed in the substrate treatment apparatus 1 through control over the portions of the substrate treatment apparatus 1 by the control unit MC.

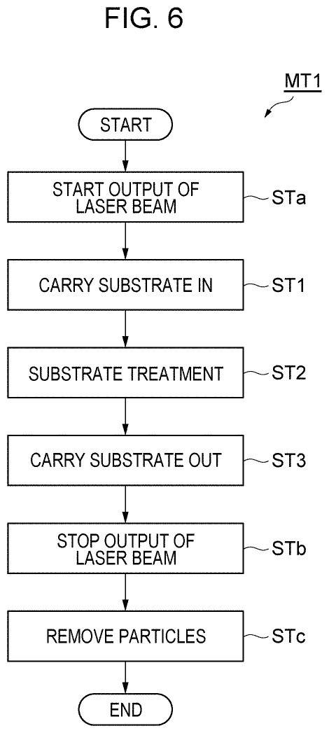

Particularly, the control unit MC can be configured to control start and stop of outputting a laser beam (which may be referred to as laser beam LB) from a light source LS. In this case, as show in FIG. 6 (described later), the control unit MC can be configured to execute control such that, after the output of a laser beam LB is started, a substrate W is carried into the chamber 10, and a substrate treatment is performed on the substrate W by using gas supplied from the gas source group 40. The control unit MC can be configured to execute control such that, after the substrate W is carried out from the chamber 10 after the substrate treatment, the output of a laser beam LB is stopped, and the inside of the chamber 10 is cleaned by using gas supplied from the gas source group 40.

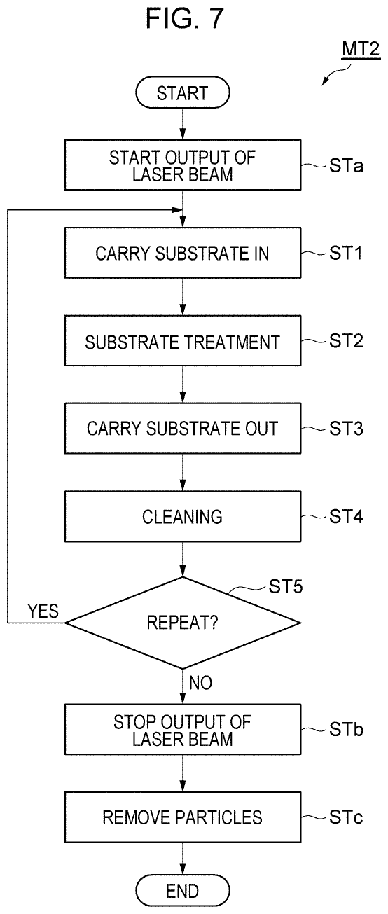

The control unit MC can control a further specific process as shown in FIG. 7 (described later) as an example. In other words, the control unit MC can be configured to execute control such that, after start of outputting a laser beam LB, a substrate is carried into the chamber 10, a substrate treatment is performed by using gas supplied from the gas source group 40, and the substrate is carried out from the chamber 10. The control unit MC can be configured to further execute control such that, after the substrate is carried out, a series of processes of cleaning the inside of the chamber 10 by using gas supplied from the gas source group 40 is repeated multiple times. The control unit MC is configured to further execute control such that, after the series of processes is repeated multiple times, the output of a laser beam LB is stopped, and the inside of the chamber 10 is cleaned by using gas supplied from the gas source group 40.

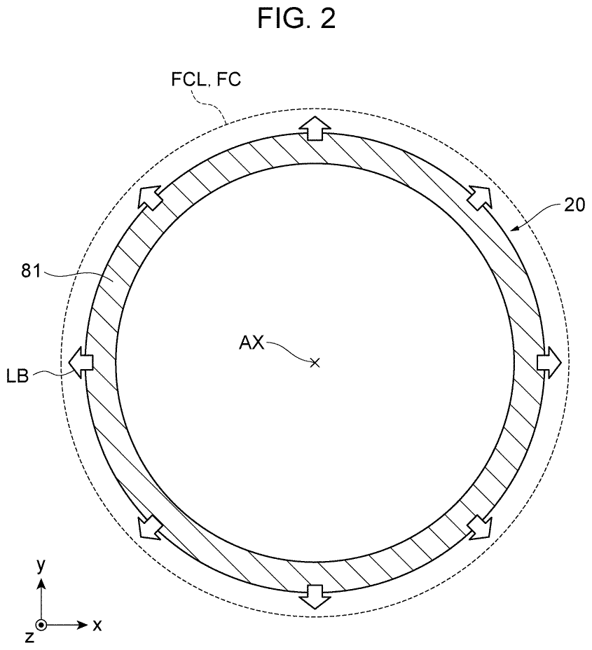

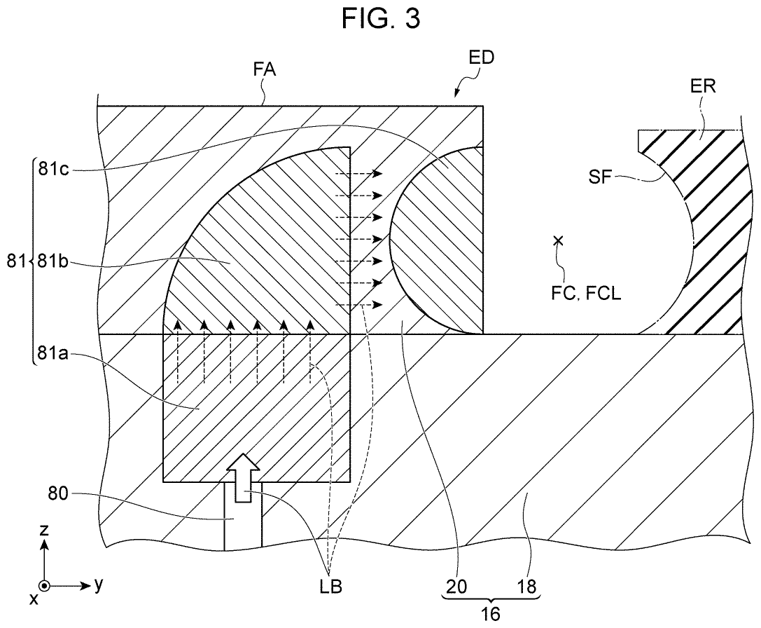

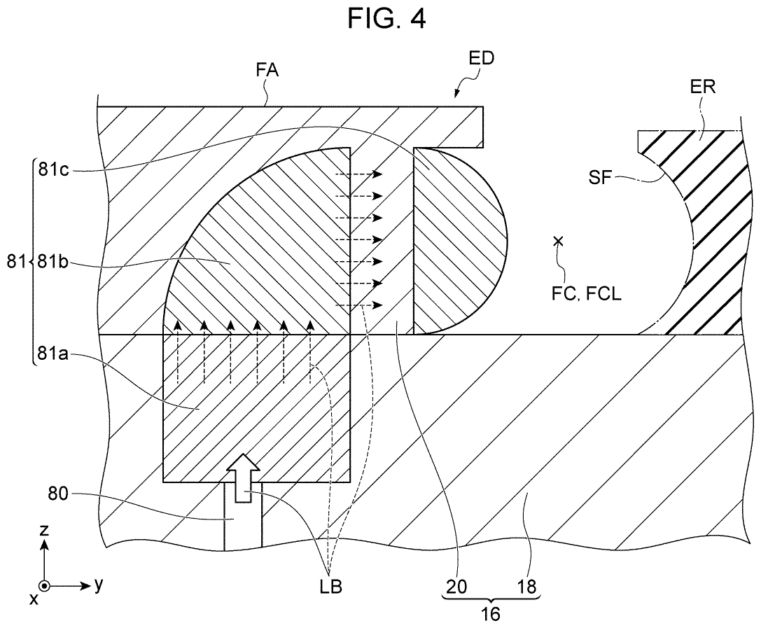

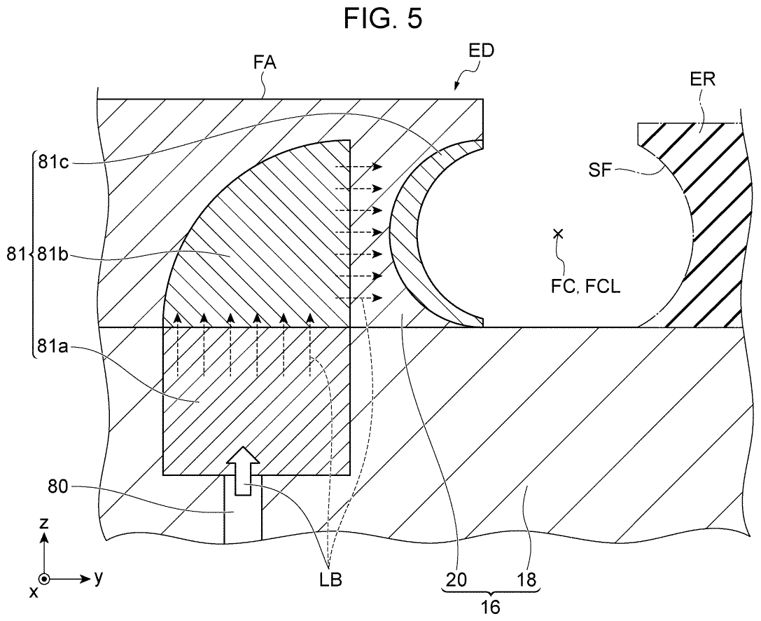

To further describe the configuration of the substrate treatment apparatus 1, hereinafter, FIG. 2 to FIG. 5 are further referenced in addition to FIG. 1. FIG. 2 is a view schematically showing the configuration of an optical system 81 according to one example. FIG. 3 is a view schematically showing the function of the optical system 81 according to one example by using the sectional shape of the optical system 81. FIG. 4 is a view schematically showing the function of another optical system 81 according to one example by using the sectional shape of the optical system 81. FIG. 5 is a view schematically showing the function of another optical system 81 according to one example by using the sectional shape of the optical system 81.

The substrate treatment apparatus 1 further includes the light source LS, an optical waveguide 80, and the optical system 81. The light source LS is configured to emit a laser beam LB. A laser beam LB emitted from the light source LS transmits through the material of the outer peripheral part of the substrate support 16 (stage). In the examples respectively shown in FIG. 3 to FIG. 5, the outer peripheral part of the substrate support 16 is the outer peripheral part ED of the electrostatic chuck 20. In this case, a laser beam LB emitted from the light source LS transmits through the material (for example, Al₂O₃ or AlN) of the electrostatic chuck 20. Hereinafter, in the present embodiment, description will be made on the assumption that the outer peripheral part of the substrate support 16 is the outer peripheral part ED of the electrostatic chuck 20 as an example.

The optical waveguide 80 is optically connected to the light source LS. The optical waveguide 80 is configured to guide a laser beam LB emitted from the light source LS. The optical waveguide 80 can be an optical fiber.

The optical system 81 is provided at the outer peripheral part ED of the substrate support 16 (stage). The optical system 81 is optically connected to the optical waveguide 80. The optical system 81 is configured to emit a laser beam LB emitted from the light source LS and guided by the optical waveguide 80 toward a focal point (a circumference FCL including the focal point FC) around the outer peripheral part ED.

The focal point FC can be present in the circumference FCL imaginarily provided so as to surround the outer peripheral part ED. For example, a plurality of focal points FC can be present in the circumference FCL. For example, a single focal point FC can make up the circumference FCL. In this case, the focal point FC is not one point but a ring shape (ring), and thus the term “focal feature” may be used to describe a single focal point, and/or a ring.

The optical system 81 includes a light diffusion portion 81a, a reflecting portion 81b, and a condensing portion 81c. The optical waveguide 80 extends from the lower side of the substrate support 16 toward the surface FA of the substrate support 16 on which a substrate is placed.

The light diffusion portion 81a may be optically connected to the optical waveguide 80 via an end portion of the optical waveguide 80. A laser beam LB emitted from the end portion of the optical waveguide 80 enters the light diffusion portion 81a via an incident plane of the light diffusion portion 81a. The incident plane extends along the surface FA of the substrate support 16 (electrostatic chuck 20). The light diffusion portion 81a is configured to diffuse the laser beam LB guided toward the surface FA by the optical waveguide 80 along the surface FA and emit the laser beam LB toward the surface FA. The laser beam LB diffused by the light diffusion portion 81a is emitted from an exit plane of the light diffusion portion 81a. The exit plane extends along the surface FA of the substrate support 16 (electrostatic chuck 20) and the incident plane of the light diffusion portion 81a. The surface FA and the outer peripheral part ED can be included in the electrostatic chuck 20.

The reflecting portion 81b is provided on the light diffusion portion 81a. The reflecting portion 81b is optically connected to the light diffusion portion 81a. The reflecting portion 81b is configured to emit a laser beam LB, emitted toward the surface FA by the light diffusion portion 81a, toward the condensing portion 81c provided adjacently to the reflecting portion 81b.

The condensing portion 81c is optically connected to the reflecting portion 81b. The condensing portion 81c is configured to condense a laser beam LB emitted from the reflecting portion 81b (more generally, a laser beam LB emitted from the light diffusion portion 81a, and the same applies among FIG. 3 to FIG. 5) to the focal point FC.

In one embodiment, as shown in FIG. 3, the condensing portion 81c can be embedded in a recess provided at the outer peripheral part ED between the reflecting portion 81b and the focal point FC.

In another embodiment, as shown in FIG. 4, the condensing portion 81c can have a convex shape protruding from the outer peripheral part ED toward the focal point FC.

In another embodiment, as shown in FIG. 5, the condensing portion 81c can have a concave shape recessed from the focal point FC toward the inner side of the outer peripheral part ED. The condensing portion 81c shown in FIG. 5 may have a shape having a uniform thickness from the outer side toward the inner side. Alternatively, as shown in FIG. 5, the condensing portion 81c may have a shape such that the thickness increases from the outer side toward the inner side (a curvature varies from the outer side toward the inner side). In this way, for the condensing portion 81c shown in FIG. 5, an appropriate shape and material for condensing a laser beam LB emitted from the condensing portion 81c to the focal point FC can be suitably selected.

A combination of the material of the electrostatic chuck 20 and the material of the condensing portion 81c enables a laser beam LB emitted from the condensing portion 81c to converge to the focal point FC according to the shape of the condensing portion 81c. For example, particularly, a plurality of materials can be applied as the condensing portion 81c by, for example, adjusting the shape of the condensing portion 81c as long as the materials are resistant to a substrate treatment (for example, resistant to plasma) and allow a laser beam LB to transmit. The material of the condensing portion 81c can be, for example, an oxide, a chemical compound, or the like containing Si, Al, Y, Hf, Zr, or Zn.

In the case shown in FIG. 3, when the material of the electrostatic chuck 20 is, for example, Al₂O₃, the material of the condensing portion 81c embedded in the recess of the outer peripheral part ED is a material having a greater refractive index than Al₂O₃ and can be, for example, AlN.

In the case shown in FIG. 4, the material of the condensing portion 81c having a convex shape can be the same as the material (for example, Al₂O₃) of the electrostatic chuck 20.

In the case shown in FIG. 5, the material of the condensing portion 81c having a concave shape is a material having resistance to a substrate treatment and can be, for example, quartz.

As shown in FIG. 3 to FIG. 5, when the substrate treatment apparatus 1 includes an edge ring ER, the material of the edge ring ER having a concave inner surface SF can be, for example, quartz having resistance to a substrate treatment. A reflector having a similar shape to that of the condensing portion 81c shown in FIG. 5 may be provided on the inner surface SF of the edge ring ER. The material of the reflector can be a material having resistance to a substrate treatment.

In one embodiment, as shown in FIG. 3 to FIG. 5, the electrostatic chuck 20 of the substrate treatment apparatus 1 may further include an edge ring placement region and the edge ring ER. The edge ring placement region extends in a circumferential direction so as to surround the substrate placement region around the central axis of the electrostatic chuck 20.

The edge ring ER is mounted on the top surface of the edge ring placement region. The edge ring ER is disposed so as to surround the outer peripheral part ED of the substrate support 16 (electrostatic chuck 20). The edge ring ER is placed on the edge ring placement region such that the central axis of the edge ring ER coincides with the axis AX. A substrate W is disposed in a region surrounded by the edge ring ER. In other words, the edge ring ER is disposed so as to surround the edge of the substrate W. The edge ring ER has an annular shape.

The focal point FC is located between the outer peripheral part ED and the inner surface SF of the edge ring ER. The inner surface SF is recessed from the focal point FC toward the inner side of the edge ring ER. The inner surface SF has a concave shape configured to reflect a laser beam LB emitted from the condensing portion 81c and condense the laser beam LB to the focal point FC.

The edge ring ER can have an electrical conductivity. The edge ring ER is made of, for example, silicon or silicon carbide. The edge ring ER may be made of a dielectric, such as quartz.

Hereinafter, FIG. 6 and FIG. 7 will be referenced. FIG. 6 is a flowchart showing a substrate treatment method MT1 according to one illustrative embodiment. FIG. 7 is a flowchart showing another substrate treatment method MT2 according to one illustrative embodiment.

In the substrate treatment method MT1 shown in FIG. 6, initially, in step STa, the output of a laser beam LB from the light source LS is started. Particles around the outer peripheral part ED can be collected to the focal point FC by the laser beam LB. In this case, the laser beam LB condensed to the focal point FC can function as optical tweezers for the particles. Therefore, diffusion of particles produced inside the chamber 10 into the chamber 10 during a substrate treatment is reduced.

After step STa, in step ST1, a substrate W is carried into the chamber 10. After step ST1, in step ST2, a substrate treatment is performed on the substrate W by using gas supplied from the gas source group 40. After step ST2, in step ST3, the substrate W is carried out from the chamber 10.

After step ST3, in step STb, the output of a laser beam LB from the light source LS is stopped. After step STb, in step STc, first cleaning is performed on the inside of the chamber 10 by using gas supplied from the gas source group 40.

In first cleaning, particles collected around the outer side of the outer peripheral part ED by a laser beam LB are removed. In first cleaning, particles may be removed by generating plasma or particles may be removed by using supply and exhaust of high flow rate gas without using plasma. Gaseous species used in first cleaning can be selected according to gaseous species or the like used in a substrate treatment performed before the first cleaning is performed.

The substrate treatment method MT2 shown in FIG. 7 is a modification of the substrate treatment method MT1 shown in FIG. 6. In the substrate treatment method MT2, initially, after step STa is performed, a series of processes including step ST1, step ST2, step ST3, and step ST4 of performing second cleaning using gas supplied from the gas source group 40 is performed. The timing to perform step ST4 for second cleaning is not limited to after step ST3 in which a substrate W is carried out as shown in FIG. 7 (each time a process on each sheet of substrate W completes) and can be various timings. For example, second cleaning can be performed each time a process on a set number of sheets (for example, one lot or several lots) of substrates W completes. Alternatively, second cleaning can be performed after a preset series of processes (for example, step STa to step ST5 shown in FIG. 6) and in a preceding step or following step of a step of stopping the output of a laser beam (for example, step STb).

After that, it is determined whether the series of processes is further repeated (step ST5). When the series of processes is further repeated (the determination of step ST5 is affirmative), the process proceeds to step ST1. When the series of processes is not further repeated (the determination of step ST5 is negative), the process proceeds to step STb. Repetition of the series of processes may be performed in, for example, each unit lot.

As described above, after the series of processes is repeated multiple times (or after the series of processes is performed once or more), step STb is performed, and step STc is performed.

Various illustrative embodiments are described above; however, not limited to the above-described illustrative embodiments, various additions, omissions, replacements, and changes may be performed. Other embodiments can be formed by combining elements in different embodiments.

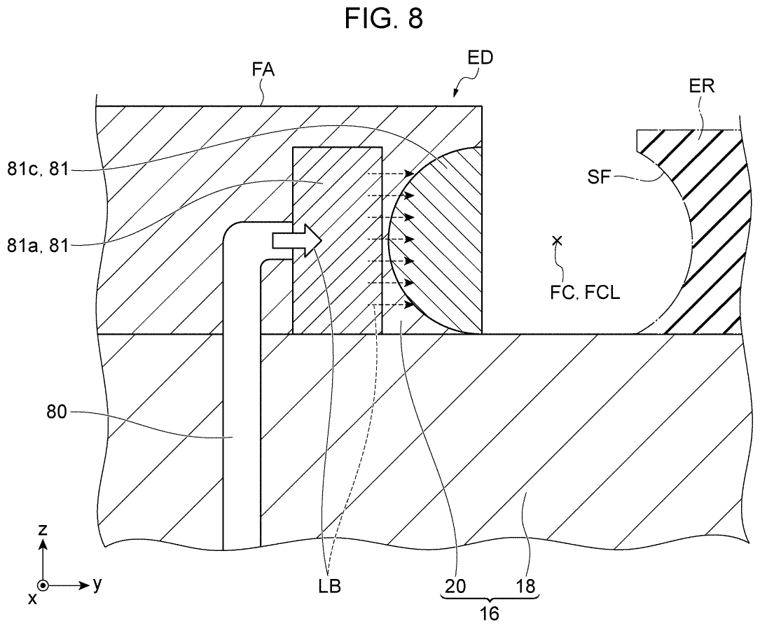

For example, in one embodiment, the configuration of an optical system 81 having no reflecting portion 81b as shown in FIG. 8 may be applied. In this case, the incident plane and exit plane of the light diffusion portion 81a extend so as to intersect with the surface FA of the substrate support 16 (electrostatic chuck 20). The optical waveguide 80 extends side by side with the light diffusion portion 81a from the lower side of the substrate support 16 toward the surface FA of the substrate support 16 on which a substrate W is placed. The optical waveguide 80 is bent toward the incident plane of the light diffusion portion 81a at a location parallel to the incident plane of the light diffusion portion 81a and optically connected to the incident plane via the end portion of the optical waveguide 80. The configuration of the optical system 81 having no reflecting portion 81b as in the case of the configuration shown in FIG. 8 can also be applied to the configuration of each of the optical systems 81 respectively shown in FIG. 4 and FIG. 5.

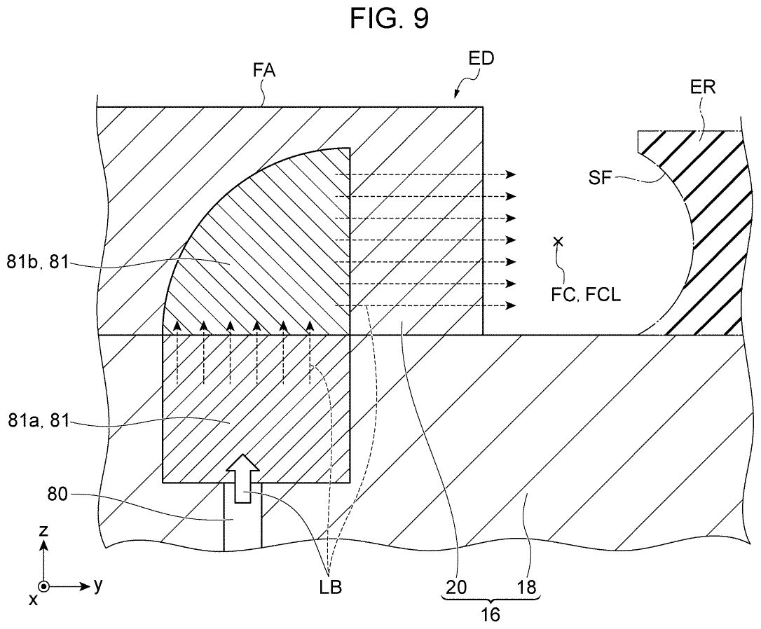

For example, in one embodiment, the configuration of an optical system 81 having no condensing portion 81c as shown in FIG. 9 may be applied. In this case, the inner surface SF of the edge ring ER is provided so as to surround the outer peripheral part ED of the electrostatic chuck 20. A laser beam LB diffused by the light diffusion portion 81a and emitted from the reflecting portion 81b is reflected by the inner surface SF toward the focal point FC and condensed to the focal point FC.

For example, in one embodiment, a convex lens (not shown) may be applied to the condensing portion 81c. In this case, for example, in the condensing portion 81c shown in FIG. 3, a lens of which only the incident side has a convex shape is applied; however, not limited to this, a convex lens of which the exit side also has a convex shape in addition to the incident side can also be applied.

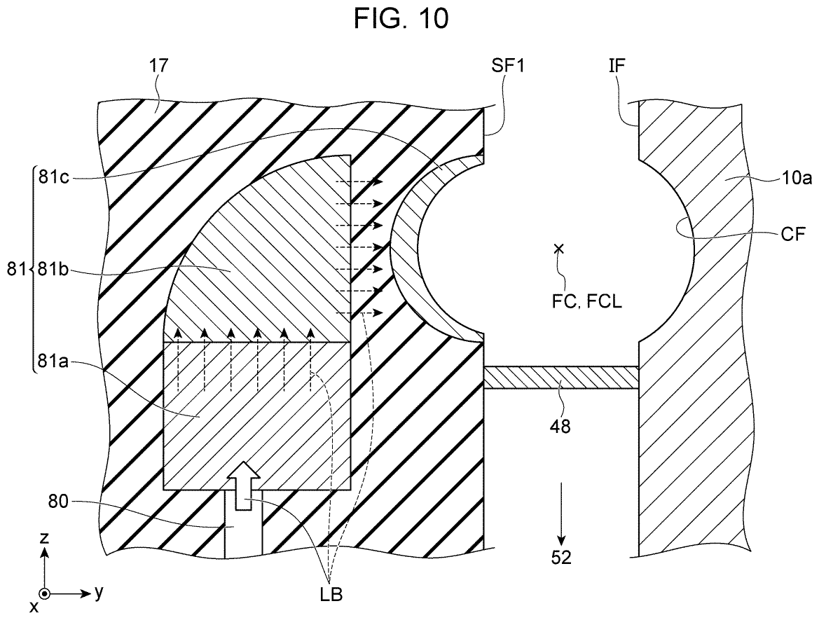

As shown in each of FIG. 10 to FIG. 17, the optical system 81 may be provided above the exhaust pipe 52. FIG. 10 to FIG. 17 respectively show substrate treatment apparatuses according to other illustrative embodiments.

In the configuration shown in FIG. 10, the optical system 81 is provided at the outer peripheral part of the support portion 17 (member) and optically connected to the optical waveguide 80. The optical system 81 is configured to emit a laser beam emitted from the light source LS and guided by the optical waveguide 80 so as to condense the laser beam LB to the focal point FC around the support portion 17. The condensing portion 81c is provided on the side SF1 of the support portion 17, facing the side wall 10a of the chamber 10. The condensing portion 81c is configured to condense the laser beam emitted from the reflecting portion 81b to the focal point FC between the side SF1 and the side wall 10a above the baffle plate 48.

A concave shape CF is provided on the inner surface IF of the side wall 10a so as to face the condensing portion 81c. The focal point FC is located between the condensing portion 81c and the concave shape CF. The concave shape CF is a shape recessed toward the inner side of the side wall 10a and configured to reflect a laser beam emitted from the condensing portion 81c and condense the laser beam LB to the focal point FC.

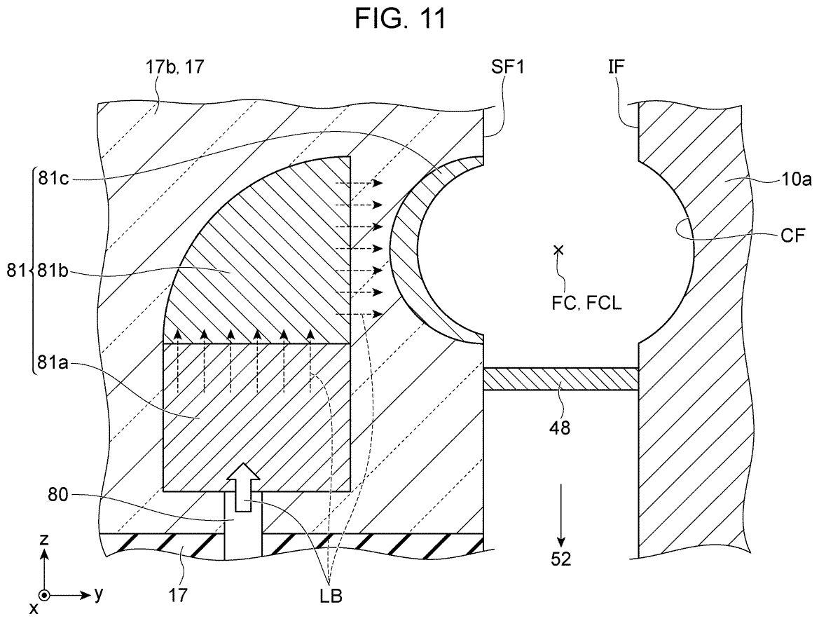

As shown in FIG. 11, in the configuration shown in FIG. 10, the support portion 17 may have a region 17b. The region 17b includes the optical system 81. The region 17b is provided separately from the support portion 17 and incorporated in the support portion 17.

The material of the region 17b may be different from that of the support portion 17. The region 17b is made of a material having a transmittance of laser beam as high as possible and can be a ceramic material containing, for example, Al, Y, Zr, Ti, Pb, Mg, O, F, or N as a main raw material. The region 17b can have a plasma resistance; however, when a coating material having a plasma resistance is provided on the surface of the region 17b, the region 17b does not need to have a plasma resistance.

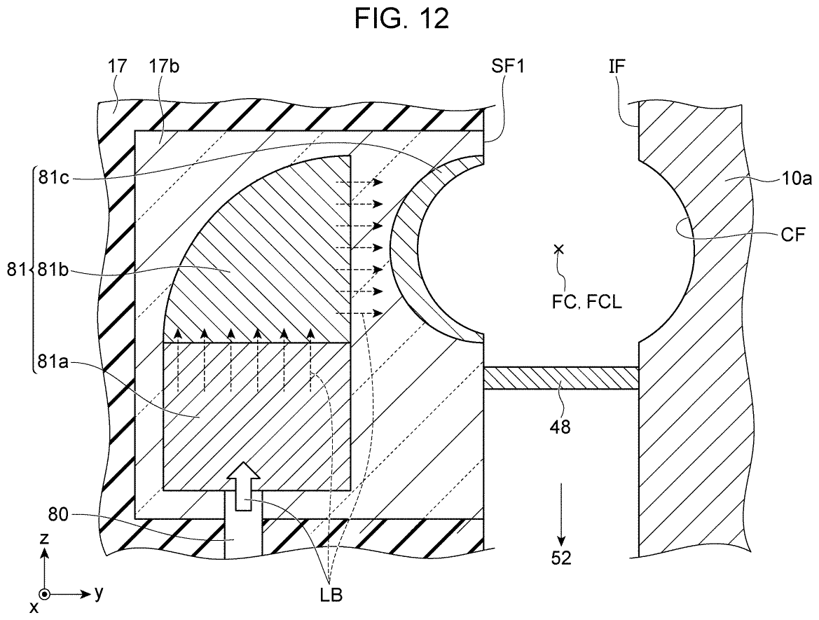

The region 17b shown in FIG. 11 can have various sizes and shapes including the optical system 81 as shown in FIG. 12.

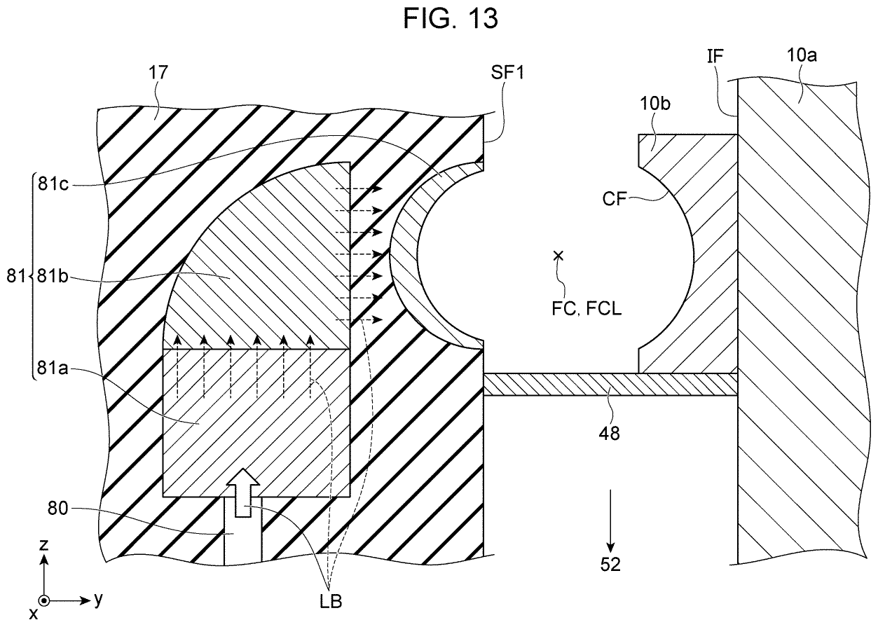

As shown in FIG. 13, in the configuration shown in FIG. 10, the concave shape CF may be provided on a concave member 10b. The concave member 10b is provided on the inner surface IF of the side wall 10a so as to face the condensing portion 81c. The focal point FC is located between the condensing portion 81c and the concave member 10b. The concave member 10b has a concave shape recessed toward the inner side of the side wall 10a and configured to reflect a laser beam emitted from the condensing portion 81c and condense the laser beam to the focal point FC. The configuration of the concave member 10b shown in FIG. 13 can also be applied to the configuration of each of FIG. 11 and FIG. 12 (the configuration that the support portion 17 includes the region 17b). The concave member 10b has a plasma resistance. The concave shape CF provided on the concave member 10b is provided so as to have a high reflectance for a laser beam.

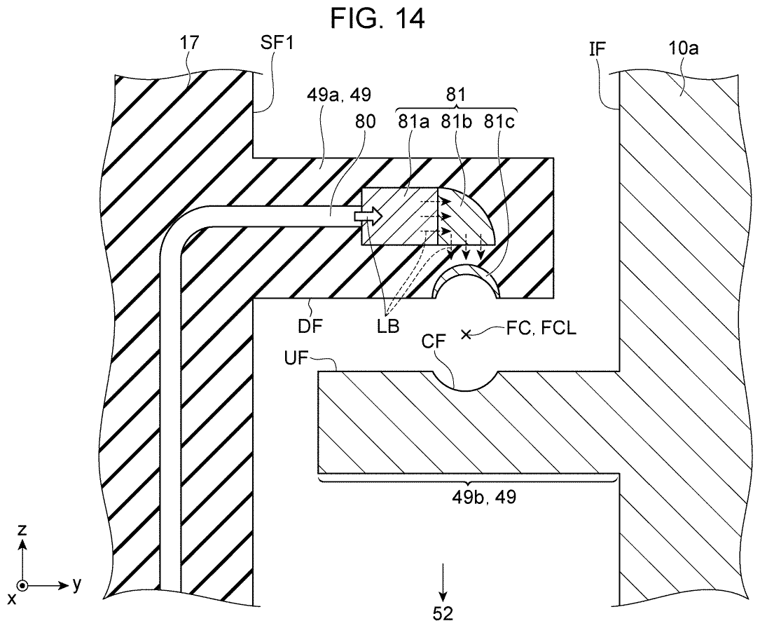

The substrate treatment apparatus 1 of the configuration shown in FIG. 14 includes a baffle portion 49 instead of the baffle plate 48. The baffle portion 49 has a first protruding portion 49a and a second protruding portion 49b. The first protruding portion 49a is provided on the support portion 17 and extends from the support portion 17 toward the side wall 10a. The second protruding portion 49b is provided on the side wall 10a below the first protruding portion 49a and extends from the side wall 10a toward the support portion 17. A gap is provided between the first protruding portion 49a and the side wall 10a and between the second protruding portion 49b and the support portion 17. The first protruding portion 49a may be disposed above the second protruding portion 49b. A bottom surface DF of the first protruding portion 49a and a top surface UF of the second protruding portion 49b may face each other and may be spaced apart from each other. The second protruding portion 49b may be provided on the side wall 10a above the first protruding portion 49a and extend from the side wall 10a toward the support portion 17.

In the configuration shown in FIG. 14, the optical system 81 is provided at the first protruding portion 49a (member) and optically connected to the optical waveguide 80. The optical system 81 is configured to emit a laser beam emitted from the light source LS and guided by the optical waveguide 80 so as to condense the laser beam LB to the focal point FC around the first protruding portion 49a. The condensing portion 81c is provided on the bottom surface DF of the first protruding portion 49a. The condensing portion 81c is configured to condense a laser beam emitted from the reflecting portion 81b to the focal point FC in a gap between the first protruding portion 49a and the second protruding portion 49b.

A concave shape CF is provided on the top surface UF of the second protruding portion 49b so as to face the condensing portion 81c. The focal point FC is located between the condensing portion 81c and the concave shape CF. The concave shape CF is a shape recessed toward the inner side of the second protruding portion 49b and configured to reflect a laser beam emitted from the condensing portion 81c and condense the laser beam LB to the focal point FC.

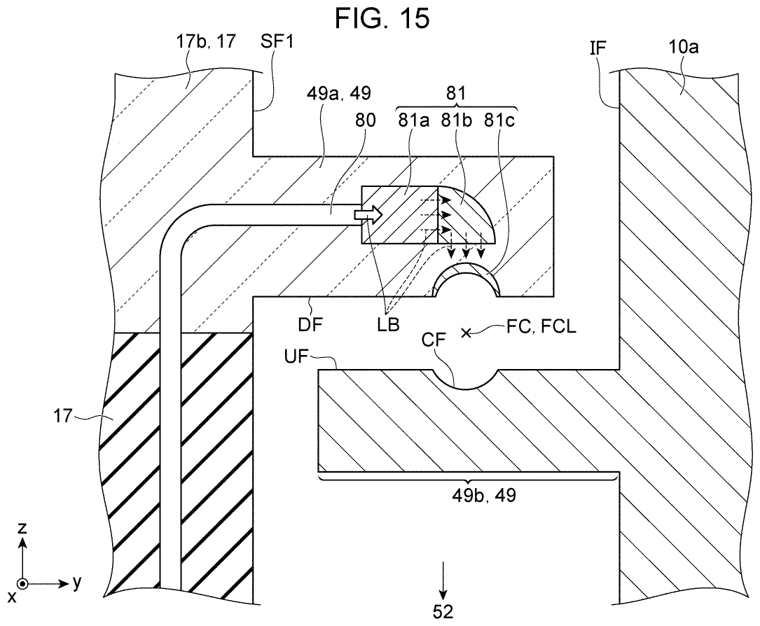

As shown in FIG. 15, in the configuration shown in FIG. 14, the support portion 17 may have a region 17b. The region 17b includes the first protruding portion 49a and the optical system 81. The region 17b is provided separately from the support portion 17 and incorporated in the support portion 17.

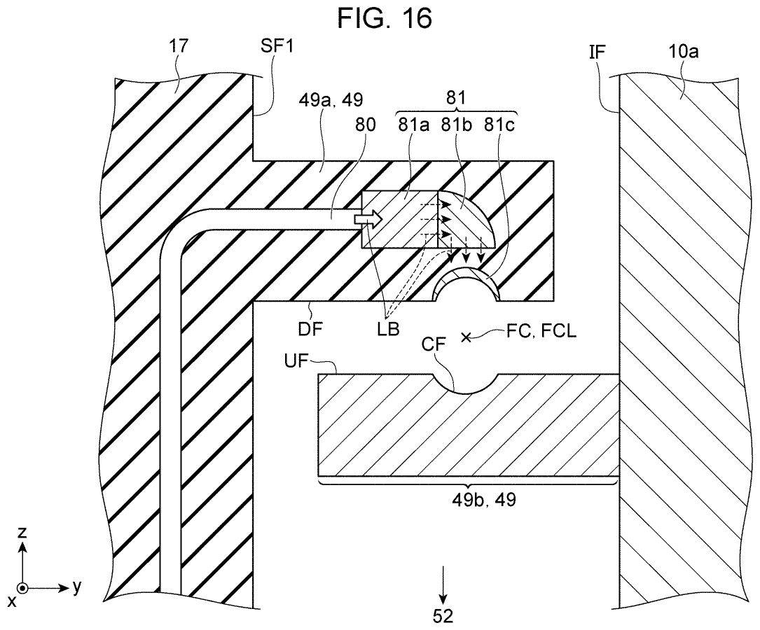

As shown in FIG. 16, in each of the configurations respectively shown in FIG. 14 and FIG. 15, the side wall 10a and the second protruding portion 49b may be provided separately from each other. The second protruding portion 49b shown in FIG. 16 may be different from the side wall 10a and can be made of a similar material to that of the concave member 10b shown in FIG. 13. The configuration of the second protruding portion 49b shown in FIG. 16 can also be applied to the configuration shown in FIG. 15 (the configuration in which the support portion 17 includes the region 17b).

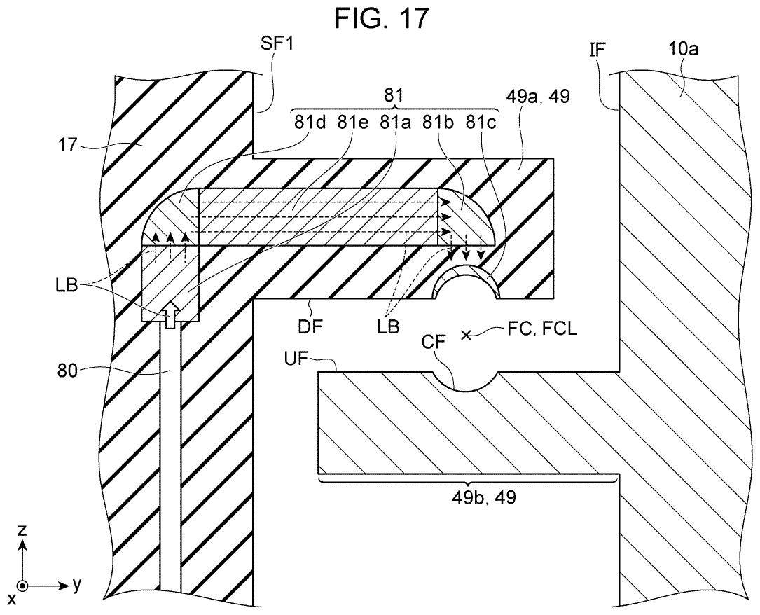

As shown in FIG. 17, for example, a reflecting portion 81d, a waveguide portion 81e, and the like may be provided between the light diffusion portion 81a and the reflecting portion 81b. In this way, a plurality of reflecting portions and a plurality of waveguide portions may be provided. The light diffusion portion 81a is optically connected to the reflecting portion 81d, the reflecting portion 81d is optically connected to the waveguide portion 81e, and the waveguide portion 81e is optically connected to the reflecting portion 81b. A laser beam entered from the light source LS to the light diffusion portion 81a via the optical waveguide 80 and diffused by the light diffusion portion 81a is reflected by the reflecting portion 81d so as to enter the waveguide portion 81e. The laser beam reflected by the reflecting portion 81d is guided by the waveguide portion 81e to reach the reflecting portion 81b, enters the reflecting portion 81b, and is reflected by the reflecting portion 81b so as to enter the condensing portion 81c. The configuration having the optical system 81 as shown in FIG. 17 can also be applied to each of the configurations respectively shown in FIG. 15 and FIG. 16 and a combination of those configurations.

From the above description, various embodiments of the present disclosure are described in the specification for illustrative purposes, and it is understood that various modifications are applicable without departing from the scope and spirit of the present disclosure. Therefore, various embodiments described in the specification are not intended for limitations, and true scope and spirit are recited in the appended claims.

1. A substrate treatment apparatus comprising:
a chamber;
a member provided inside the chamber;
a light source configured to emit a laser beam;
an optical waveguide optically connected to the light source and configured to guide a laser beam emitted from the light source; and
an optical system provided at an outer peripheral part of the member, optically connected to the optical waveguide, and configured to emit a laser beam emitted from the light source and guided by the optical waveguide so as to condense the laser beam to a focal feature around the member.

2. The substrate treatment apparatus according to claim 1, wherein
the optical system includes a light diffusion portion and a condensing portion,
the light diffusion portion is optically connected to the optical waveguide via an end portion of the optical waveguide, and
the condensing portion is configured to condense light originating from the laser beam and emitted from the light diffusion portion to the focal feature, wherein the focal feature being at least one of a focal point or at least a portion of a focal point circumference.

3. The substrate treatment apparatus according to claim 2, wherein
the optical system further includes a reflecting portion, wherein
the light diffusion portion is configured to diffuse and emit light from the laser beam guided to the light diffusion portion by the optical waveguide,
the reflecting portion is provided on the light diffusion portion, optically connected to the light diffusion portion, and configured to emit light emitted from the light diffusion portion, toward the condensing portion provided adjacent to the reflecting portion, and
the condensing portion is optically connected to the reflecting portion and configured to condense the light emitted from the reflecting portion to the focal feature.

4. The substrate treatment apparatus according to claim 2, wherein the focus feature is the focal point, and the condensing portion has a convex shape protruding from the outer peripheral part toward the focal point.

5. The substrate treatment apparatus according to claim 2, wherein the focus feature is the focal point, and the condensing portion has a concave shape recessed from the focal point toward an inside of the outer peripheral part.

6. The substrate treatment apparatus according to claim 3, wherein the focus feature is the focal point, and the condensing portion is embedded in a recess provided at the outer peripheral part between the reflecting portion and the focal point.

7. The substrate treatment apparatus according to claim 2, further comprising an edge ring disposed so as to surround the outer peripheral part, wherein
focus feature is the focal point, and the focal point is located between the outer peripheral part and an inner surface of the edge ring, and
the inner surface has a concave shape recessed from the focal point toward an inner side of the edge ring and configured to reflect light emitted from the condensing portion and condense the light to the focal point.

8. The substrate treatment apparatus according to claim 1, further comprising circuitry configured to control start and stop of the light source so as to control an emission of the laser beam.

9. The substrate treatment apparatus according to claim 8, further comprising a gas source group, wherein
the circuitry is configured to, after controlling the light source to emit the laser beam,
control a substrate to be carried into the chamber, so the substrate is subjected
to a substrate treatment with gas supplied from the gas source group,
control the substrate to be carried out of the chamber,
control the light source to cease emission of the laser beam, and
control the gas source group to supply gas to remove particles from the chamber.

10. The substrate treatment apparatus according to claim 9, wherein the circuitry is further configured to, after controlling the laser beam to emit the laser beam, control a repeated series of processes that cause a substrate to be carried into the chamber, subject the substrate to the substrate treatment, carry the substrate out of the chamber multiple times, and then control the light source to cease emission of the laser beam, and then control a process to remove the particles.

11. The substrate treatment apparatus according to claim 1, wherein the member is a substrate support provided inside the chamber and configured to support a substrate.

12. The substrate treatment apparatus according to claim 11, further comprising a circuitry that controls operation of a plasma process in the chamber that treats the substrate supported by the substrate support with plasma.

13. The substrate treatment apparatus according to claim 11, wherein
the substrate support includes an electrostatic chuck, and
the electrostatic chuck includes the outer peripheral part.

14. The substrate treatment apparatus according to claim 3, further comprising:
a substrate support configured to support a substrate;
a support portion extending upward from a bottom of the chamber and configured to support the substrate support;
an exhaust pipe connected to the bottom; and
a baffle plate provided between a side wall of the chamber and the support portion above the exhaust pipe, wherein
the member is the support portion, and
the condensing portion is provided on a side of the support portion, facing the side wall, and is configured to condense light emitted from the reflecting portion to the focal point between the side and the side wall above the baffle plate.

15. The substrate treatment apparatus according to claim 3, further comprising:
a substrate support configured to support a substrate;
a support portion extending upward from a bottom of the chamber and configured to support the substrate support;
an exhaust pipe connected to the bottom; and
a baffle portion provided between a side wall of the chamber and the support portion above the exhaust pipe, wherein
the baffle portion has a first protruding portion provided on the support portion and extending from the support portion toward the side wall, and a second protruding portion provided on the side wall above or below the first protruding portion and extending from the side wall toward the support portion,
a gap is provided between the first protruding portion and the side wall and between the second protruding portion and the support portion,
at least one of a bottom surface of the first protruding portion and a top surface of the second protruding portion face each other and are spaced apart from each other, or, a top surface of the first protruding portion and a bottom surface of the second protruding portion face each other and are spaced apart from each other,
the member is the first protruding portion, and
the condensing portion is provided on the bottom surface of the first protruding portion and configured to condense a light emitted from the reflecting portion to the focal point in a gap between the first protruding portion and the second protruding portion.

16. The substrate treatment apparatus according to claim 14, wherein
a concave shape is provided on an inner surface of the side wall so as to face the condensing portion,
the focal feature is a focal point located between the condensing portion and the concave shape, and
the concave shape is a shape recessed toward an inner side of the side wall and configured to reflect light emitted from the condensing portion and condense the light to the focal point.

17. The substrate treatment apparatus according to claim 15, wherein
a concave shape is provided on the top surface of the second protruding portion so as to face the condensing portion,
the focal feature is a focal point located between the condensing portion and the concave shape, and
the concave shape is a shape recessed toward an inner side of the second protruding portion and configured to reflect light emitted from the condensing portion and condense the light to the focal point.

18. A substrate treatment method performed in a substrate treatment apparatus, comprising:
emitting a laser beam from a light source into a chamber in the substrate treatment apparatus, a member provided inside the chamber, an optical waveguide optically connected to the light source and configured to guide a laser beam emitted from the light source, an optical system provided at an outer peripheral part of the member, optically connected to the optical waveguide, and configured to condense a laser beam guided by the optical waveguide to a focal feature located around the outer peripheral part;
carrying in a substrate into the chamber;
performing a substrate treatment on the substrate by using gas supplied from a gas source group;
carrying out the substrate out from the chamber;
stopping emission of the laser beam from the light source; and
removing particles by using gas supplied from the gas source group.

19. The substrate treatment method according to claim 18, wherein, the stopping and performing is performed after a multiple iterations of the carrying in, the performing the substrate treatment, and the carrying out are performed in series.

20. The substrate treatment method according to claim 18, wherein the substrate treatment is a plasma treatment of treating the substrate with plasma.
